(19) United States
(12) Patent Application Publication
(10) Pub. No.: US 2019/0094596 A1
(43) Pub. Date: Mar. 28, 2019

(54) RGBX DISPLAY PANEL AND LIQUID CRYSTAL DISPLAY DEVICE

(71) Applicant: Wuhan China Star Optoelectronics Technology Co., Ltd., Wuhan (CN)

(72) Inventors: Jun XIA, Shenzhen (CN); Qingcheng ZUO, Shenzhen (CN)

(21) Appl. No.: 16/058,635

(22) Filed: Aug. 8, 2018

Related U.S. Application Data
(63) Continuation of application No. PCT/CN2018/071960, filed on Jan. 9, 2018.

(30) Foreign Application Priority Data
Sep. 26, 2017 (CN) 201710883545.5

(51) Int. Cl. G02F 1/1339; G02F 1/1362; G02F 1/1368

(52) U.S. Cl. CPC G02F 1/13394; G02F 1/136286; G02F 2001/13398; G02F 2201/52; G02F 1/1368

(57) ABSTRACT

An embodiment of the present invention discloses an RGBX display panel, including: a plurality of sub-pixels defined by an intersection of a plurality of scan lines and a plurality of data lines and arranged in an array manner. The plurality of sub-pixels includes a plurality of red sub-pixel, a plurality of green sub-pixels, a plurality of blue sub-pixels, and a plurality of X color sub-pixels; the X color is different from red, green and blue; a plurality of first thin film transistors; a ratio of an area of the X color sub-pixel blocked by the spacer to an X color sub-pixel area is a and 10%≤a<100%. The present embodiment also discloses a liquid crystal display device. According to the present disclosure, there is an advantage that picture quality can be improved.

### RELATED APPLICATIONS

This application is a continuation application of PCT Patent Application No. PCT/CN2018/071960, filed Jan. 9, 2018, and claims the priority of China Application No. CN 201710883545.5, filed Sep. 26, 2017, which is herein incorporated by reference in its entirety.

### FIELD OF THE DISCLOSURE

The present invention relates to the field of display technology, and in particular, to an RGBX display panel and a liquid crystal display device.

### BACKGROUND

In order to improve the light transmittance of the liquid crystal display panel, the prior art proposes that an X color sub-pixel is added to the R color sub-pixel, the G color sub-pixel and the B color sub-pixel. X color is Y (yellow), C (cyan) or M (magenta), etc. However, the proportion of the RGB three colors decreases and the proportion of the X color increases due to the addition of the X color sub-pixels.

In order to keep the gap between the array substrate and the color filter substrate of the liquid crystal display panel consistent, the prior art places photo spacers (PS) at the thin film transistors at the intersections of the scanning lines and the data lines of the liquid crystal display panel. The spacers block parts of the R color sub-pixels, the G color sub-pixels, the B color sub-pixels and the X color sub-pixels and especially the ratio of the area of the spacer shielding the X color sub-pixels to the total area of the X color sub-pixels Is 3%, and the proportion of the R color sub-pixels, the G color sub-pixels and the B color sub-pixels covered by the spacer respectively occupying the total area of the R color sub-pixels, the G color sub-pixels and the B color sub-pixels is greater than 3% so that the proportion of X color will increase. As a result, the overall solid color has a low specific proportion. For example, the ratio of yellow and white color in the four color RGBWs is low. Please see Table 1 below, resulting in a poor picture quality.

TABLE 1

| | | Transmittance for | Transmittance | Ratio of |
|---|---|---|---|---|
| | Transmit- | R + G + B + W | for R + G | Yellow and |
| Color | tance | (White) | (Yellow) | white (Y/W) |
| R | 0.85% | 8.11% | 3.27% | 40.3% |
| G | 2.42% | | | |
| B | 0.36% | | | |
| Only W | 4.48% | | | |

### SUMMARY

The technical problem to be solved in the embodiments of the present invention is to provide an RGBX display panel and a liquid crystal display device for improving the picture quality.

In order to solve the above technical problem, an embodiment of the present invention provides an RGBX display panel, comprising: a plurality of scan lines; a plurality of data lines insulated from and intersecting with the plurality of scan lines; a plurality of sub-pixels defined by an intersection of the plurality of scan lines and the plurality of data lines, and arranged in an array manner; the plurality of sub-pixels comprising a plurality of red sub-pixels, a plurality of green sub-pixels, a plurality of blue sub-pixels pixels, a plurality of X color sub-pixels, wherein the X color is different from red, green and blue; a plurality of first thin film transistors; a plurality of spacers, wherein an area ratio of a region of the X color sub-pixel blocked by the spacers to a region of the X color sub-pixel is a and 10%≤a<100%.

Optionally, 30%≤a≤70%.

Optionally, the X color sub-pixel is a white sub-pixel, a yellow sub-pixel, a cyan sub-pixel, or a magenta sub-pixel.

Optionally, all of the spacers are disposed around a plurality of the X color sub-pixels or within a plurality of the X color sub-pixels.

Optionally, projections of the spacers located in a display area partially overlap or completely overlap areas of the X color sub-pixel.

Optionally, the spacer comprises a second spacer disposed around the X color sub-pixel, and at least partial projections of a center point of the second spacer on the horizontal plane falls within the X color sub-pixel or close to the X color sub-pixel.

Optionally, the spacer further comprises a first spacer, the projection of the first spacer on the horizontal plane is located between the two of red sub-pixel, the green sub-pixel and the blue sub-pixel.

Optionally, all of the spacers are located outside an intersectional overlapping area of the data line and the scan line.

Optionally, an aperture ratio of the X color sub-pixel is smaller than an aperture ratio of the red sub-pixel, the green sub-pixel and the blue sub-pixel.

An embodiment of the second aspect of the present disclosure provides a liquid crystal display panel, including the above RGBX display panel.

The implementation of the embodiments of the present disclosure has the following beneficial effects:

Since the RGBX display panel includes a plurality of spacers, a ratio of an area of the X color sub-pixel blocked by the spacer to an area of the X color sub-pixel is a and 10%≤a<100%. As a result, the specific gravity of the X color can be reduced, the overall solid color proportion can be increased, and the quality of the screen can be improved.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic view of an RGBX display panel according to a first embodiment of the present disclosure;

FIG. 2 is a schematic view of a RGBX display panel according to a second embodiment of the present disclosure;

FIG. 3 is a schematic diagram of an RGBX display panel according to a third embodiment of the disclosure.

### DETAILED DESCRIPTION OF PREFERRED EMBODIMENTS

In order to understand the above objectives, features and advantages of the present disclosure more dearly, the present disclosure is described in detail below with references to the accompanying drawings and specific embodiments.

In the disclosure, it should be noted that the terms such as central, above, under, left, right, perpendicular, horizontal, inner, outer, and etc. are for briefly illustrating the direction or relationship between positions based on the drawings. The disclosure does not intend to limit the operation or the structure of the mentioned devices or elements thereto. Further, the terms such as first, second, third, and etc. are for illustrating purpose, so they should not be interpreted as the indication or hint of the sequence of importance.

### First Embodiment

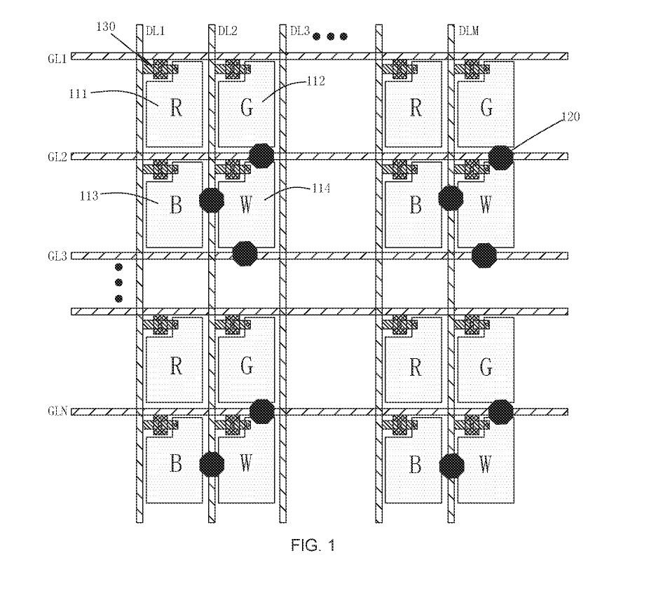

The present disclosure provides a RGBX display panel. Please refer to FIG. 1, an RGBX display panel includes a plurality of scan lines GL1-GLN, a plurality of data lines DL1-DLM, a plurality of sub-pixels, a plurality of first thin film transistors 130 and a plurality of spacers 120.

The plurality of scan lines GL1-GLN extend in the X-axis direction, and the plurality of scan lines GL1-GLN are parallel to each other. In this embodiment, the number of the scan lines is N, where N is an integer greater than or equal to two.

The plurality of data lines DL1-DLM extend in the Y-axis direction, and the data lines DL1-DLM are parallel to each other. In this embodiment, the number of the data lines is M, where M is an integer greater than or equal to two. The plurality of data lines DL1-DLM are insulated from each other and intersected with the plurality of scan lines GL1-GLN.

A plurality of sub-pixels is defined by a plurality of the scan lines GL1-GLN and a plurality of the data lines DL1-DLM. Specifically, a single sub-pixel is disposed in an area surround between two adjacent scan lines and two adjacent data lines. The sub-pixels are arranged in an array manner. In this embodiment, the plurality of sub-pixels include a plurality of red (R) color sub-pixels 111, a plurality of green (G) color sub-pixels 112, a plurality of blue (B) color sub-pixels 113 and a plurality of X colors sub-pixel, wherein one red sub-pixel 111, one green sub-pixel 112, one blue sub-pixel 113 and one X color sub-pixel form one pixel, and the arrangement of four sub-pixels in one pixel may be arranged in RGBX stripes, Alternatively, two rows may be arranged in two rows or arranged in another row, and the display panel may be periodically arranged in units of pixels. In this embodiment, the X color is different from the red, green and blue colors. Specifically, in the present embodiment, the X color sub-pixel is a white (W) color sub pixel 114. One pixel includes RGBW four sub-pixels. However, the present invention is not limited thereto. In other embodiments of the present disclosure, the X color sub-pixel may be a yellow (Y) sub-pixel, a cyan (C) sub-pixel or a magenta (M) sub-pixel.

In this embodiment, each of the first thin film transistors 130 is disposed corresponding to the sub-pixel. Each of the first thin film transistors 130 has a gate electrically connected to a corresponding scan line, a source electrically connected to a corresponding data line, and a drain electrode connect the corresponding sub-pixel. When the scan line outputs a high level, the first thin film transistor 130 electrically connected to the scan line is turned on. At this time, the data line transmits a corresponding image signal so as to charge the corresponding sub-pixel When the scan line outputs a low level, the first thin film transistor 130 electrically connected to the scan line is turned off, and at this time, the charged sub-pixel charges are maintained. However, the present invention is not limited thereto. In other embodiments of the present invention, one sub-pixel may also be disposed corresponding to multiple thin film transistors in order to improve performance. This solution or other conventional solutions known to those of ordinary skill in the art should also be included within the scope of the present invention.

In this embodiment, in order to keep the gaps between the liquid crystal layers of the display panel consistent, a plurality of spacers 120 are disposed in the liquid crystal layer. The spacers 120 are located above the scanning lines, above the data lines, or at the area except for the overlapping area of the data lines and the scan line above the thin film transistor 130. In this embodiment, the spacer 120 is a cylindrical body, such as a cylindrical body, an octagonal prism, a cube, etc. The diameter of the spacer 120 is greater than the width of the scan line and the width of the data line. The spacer 120 blocks portions of the sub-pixels, for example, a portion of the partial red sub-pixel 111, the partial green sub-pixel 112, the partial blue sub-pixel 113 and the partial X color sub-pixel.

In order to increase the specific gravity of the entire solid color, in the present embodiment, the area where the spacer 120 shields the X sub-pixel is increased, specifically, the ratio of the area of the X color sub-pixel blocked by the spacer 120 to the X color sub pixel area is a, the value of a is increased from 3% of the prior art to 10% or more, specifically 10%≤a<100%, for example a is 10%, 15%, 20%, 25%, 30% 35%, 40%, 45%, 50%, 55%, 60%, 65%, 70%, 75%, 80%, 85%, 90% and 95%. When the value of a is increased, the specific gravity of the X color can be reduced and the overall solid color proportion can be increased. For example, the yellowish white ratio in the four RGBW color increases, as shown in Table 2 below. The 40.3% of the technology is increased to 49.6%, so that the quality of the picture can be improved. Preferably, in this embodiment, the range of a is: 30%≤a≤70%. In this case, the display panel has better picture quality and better transmittance.

TABLE 2

| | | Transmittance for | Transmittance | Ratio of |
|---|---|---|---|---|
| | Transmit- | R + G + B + W | for R + G | Yellow and |
| Color | tance | (White) | (Yellow) | white (Y/W) |
| R | 0.91% | 7.05% | 3.50% | 49.6% |
| G | 2.59% | | | |
| B | 0.39% | | | |
| Only W | 3.16% | | | |

In order to increase the value of a, referring to FIG. 1, in the present embodiment, all of the spacers 120 are disposed around a plurality of the X color sub-pixels. Specifically, the spacers 120 are located above the scan line and the data line. The center of the spacer 120 is located above the scan line or above the data line. For example, the center point of the spacer 120 is located directly above the center line of the scan line or the data line so that the spacer 120 blocks both the area of the W color sub-pixel 114 and the area of the sub-pixel adjacent to the W color sub-pixel 114. In FIG. 1, the spacer 120 also blocks portion of the G color sub-pixel 112 and portion of the B color sub-pixel 113. In this embodiment, since all of the spacers 120 are disposed around the X color sub-pixel, the spacer 120 mainly blocks the X color sub-pixel and partially blocks the R-color sub-pixel 111 adjacent to the X color sub-pixel, the G color sub-pixel 112 and the B color sub-pixel 113 (the arrangement of RGBW may be different from the arrangement of FIG. 1), so that transmittance of the X-ray sub-pixel will be greatly reduced, while transmittance of the R color sub-pixel 111, the G color sub-pixel 112 and the B color sub-pixel 113 is increased so that the value of a increases the range of 10% to 100%. At the same time, the aperture ratio of the X color sub-pixel is smaller than the aperture ratio of the red sub-pixel, the green sub-pixel and the blue sub-pixel because the spacer 120 mainly blocks the X color sub-pixel. In addition, in other embodiments of the present invention, in order to further improve the transmittance of the R color sub-pixel, the G color sub-pixel, and the B color sub-pixel and reduce the transmittance of the X color sub-pixel, all of the spacers are located in the area of the X color sub-pixels, i.e., the projections of all the spacers in the horizontal plane are located in the areas of the plurality of X color sub-pixels. In addition, in other embodiments of the present invention, a small number of spacers may also be disposed around the X color sub-pixel or not in the area of the X color sub-pixel, i.e., most of the spacers surround the X color sub-pixel is disposed or located in the area of the X color sub-pixel, and a small part of spacers may surround the R color sub-pixel, the G color sub-pixel and the B color sub-pixel without surrounding the X color sub-pixel or located in the region of the X color sub-pixel (Arrangement of RGBX four-color sub-pixel may be different from FIG. 1). In addition, in other embodiments of the present invention, all of the spacers may also be located outside the intersection overlapping area of the data line and the scan line.

In this embodiment, in order to keep the gap of the liquid crystal layer of the display panel consistent, all of the spacers 120 are uniformly disposed around a plurality of the X color sub-pixels or uniformly within the plurality of X color sub-pixels. The spacers 120 are evenly distributed in the periphery of the X color sub-pixel or in the region of the X color sub-pixel.

In the present embodiment, the spacer 120 includes a main spacer 120 that serves as a main supporting member and a sub-spacer 120 that supports the main spacer 120 after being compressed. In this embodiment, in order to make the spacer 120 have the function of blocking light, the spacer 120 is made of opaque photoresist material.

In addition, an embodiment of the present invention further provides a liquid crystal display device, which includes the RGBX display panel and the backlight module as described above, and the backlight module is located under the RGBX display panel. The RGBX display panel provides the light source.

### Second Embodiment

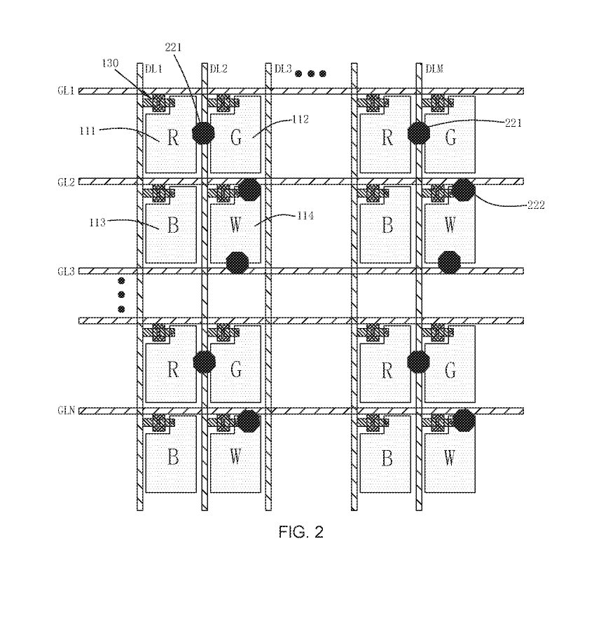

FIG. 2 is a schematic diagram of a RGBX display panel according to a second embodiment of the present invention. The schematic diagram of FIG. 2 is similar to the schematic diagram of FIG. 1, and therefore, the same reference numbers refer to the same components. The present embodiment is arranged in a position different from that of the spacer of the first embodiment.

In order to increase the value of a, referring to FIG. 2, in this embodiment, the R color sub-pixel 111, the G color sub-pixel 112, the B color sub-pixel 113 and the W color sub-pixel 114 are all surrounded by a spacer for distinguishing the spacer. The spacers whose projections on the horizontal plane are located between any two of the R color sub-pixel 111, the G color sub-pixels 112, the B color sub-pixels 113 are referred as a first spacer 221. The first spacer 221 occupies as a minority, the spacer surrounding the W color sub-pixel 114 is referred to as a second spacer 222, and the second spacer 222 is a majority. In the present embodiment, the first spacer 221 is located above the data line. Preferably, the center point of the first spacer 221 is located directly above the center line of the data line. However, the present invention is not limited thereto. In other embodiments of the present invention, the first spacer may also be located above the scan line.

In the present embodiment, the projection of all the second spacers 222 in the horizontal plane completely overlaps with the area where the W color sub-pixel 114 is located, and all the projections of the second spacers 222 are located in the W color sub-pixel 114, In this case, the projection of the center point of the second spacer 222 in the horizontal plane falls within the W color sub-pixel 114. There are two cases where one is that the entire second spacer 222 is located within the W sub-pixel 114. And the other case is that the projection of the center point of the second spacer 222 in the horizontal plane falls within the W color sub-pixel 114, and some of the second spacers are located above the scan line (the case in FIG. 2). At this time, the second spacer 222 does not block the R color sub-pixel 111, the G color sub-pixel 112 and the B color sub-pixel 113, so that the transmittance of the W color sub-pixel 114 decreases, The transmittance of the sub-pixel 112 and the B-color sub-pixel 113 is increased so that the value of a is increased to a range of 10% to 100%, and the specific gravity of the W color can be reduced. The overall solid color proportion increases, and the yellow-white color ratio increases. See table 2 above. In addition, in this embodiment, the second spacer may also be partially overlapped with the area where the W color sub-pixel is located in the projection of the horizontal plane. In this case, the second spacer blocks more W color sub-pixels and blocks less other sub-pixels adjacent to the W color sub-pixel or not. In addition, in other embodiments of the present invention, a part of the projection of the center point of the second spacer in the horizontal plane falls on the center line of the scan line or the center line of the data line.

### Third Embodiment

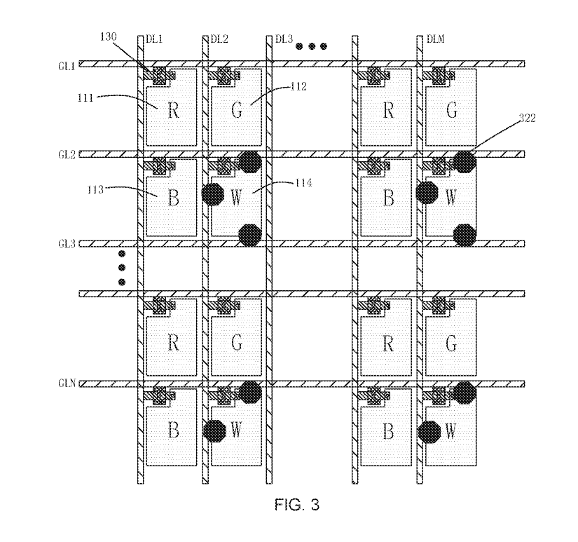

FIG. 3 is a schematic diagram of an RGBX display panel according to a third embodiment of the present invention. The schematic diagram of FIG. 3 is similar to the schematic diagram of FIG. 2, and therefore, the same reference numbers denote the same components. The main difference between this embodiment and the second embodiment is the absence of the first spacer.

Referring to FIG. 3, in the present embodiment, all of the spacers are the second spacers 322. The first spacers do not exist. The projection of the second spacers 322 located in the display area is equal to the areas where the location of the X color sub-pixels partially overlap or completely overlap with each other. In this case, the value of a can be greatly increased and the overall solid-color proportion can be increased, so that the quality of the display panel picture can be greatly improved.

It should be noted that, each embodiment in this specification is described in a progressive manner, and each embodiment focuses on differences from other embodiments. The same and similar parts among the embodiments refer to each other. Since the apparatus embodiment is basically similar to the method embodiments, the description is relatively simple, and for the relevant parts, reference may be made to the part of the method embodiments.

Through the description of the above embodiments, the present invention has the following advantages:

Since the RGBX display panel includes a plurality of spacers, a ratio of an area of the X color sub-pixel blocked by the spacer blocking to an area of the X color sub-pixel is a and 10%≤a<100%. As a result, the specific gravity of the X color can be reduced, the overall solid color proportion can be increased, and the quality of the screen can be improved.

In the present disclosure, the opening area of the X color sub-pixel is smaller than the opening area of the RGB tri-color sub-pixel. It can be reserved a sufficient area for accommodating the spacers, but the specific gravity of the X color can also be reduced and the overall solid color proportion can be increased.

In the prior art, as far as possible, the spacers are disposed in the overlapping area of the scan lines and the data lines to increase the aperture ratio. However, in the present invention, the conventional technical bias is changed so that all the spacers deviate from the overlapping area of the scan lines and the data lines and RGB tri-color sub-pixel area. The spacers is arranged in the area where the X color sub-pixels are located, so as to reduce the specific gravity of the X color, improve the overall solid color specific gravity and improve the picture quality.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. An RGBX display panel, comprising:
a plurality of scan lines;
a plurality of data lines, insulated from and intersecting with the plurality of scan lines;
a plurality of sub-pixels, defined by an intersection of the plurality of scan lines and the plurality of data lines and arranged in an array manner, the plurality of sub-pixels comprising a plurality of red sub-pixels, a plurality of green sub-pixels, a plurality of blue sub-pixels pixels and a plurality of X color sub-pixels, wherein the X color is different from red, green and blue;
a plurality of first thin film transistors; and
a plurality of spacers, wherein an area ratio of a region of the X color sub-pixel blocked by the spacers to a region of the X color sub-pixel is a, and 10%≤a<100%.

2. The RGBX display panel according to claim 1, wherein 30%≤a≤70%.

3. The RGBX display panel according to claim 1, wherein the X color sub-pixel is a white sub-pixel, a yellow sub-pixel, a cyan sub-pixel or a magenta sub-pixel.

4. The RGBX display panel according to claim 1, wherein all of the spacers are disposed around a plurality of the X color sub-pixels or within an area of the plurality of the X color sub-pixels.

5. The RGBX display panel according to claim 1, wherein projections of the spacers located in a display area partially or completely overlap with an area of the X color sub-pixel.

6. The RGBX display panel according to claim 1, wherein the spacer comprises a second spacer disposed around the X color sub-pixel, and at least partial projections of a center point of the second spacer on the horizontal plane falls within the X color sub-pixel or close to the X color sub-pixel.

7. The RGBX display panel according to claim 6, wherein the spacer further comprises a first spacer, the projection of the first spacer on the horizontal plane is located between the two of red sub-pixel, the green sub-pixel and the blue sub-pixel.

8. The RGBX display panel according to claim 1, wherein all of the spacers are located outside an intersectional overlapping area of the data line and the scan line.

9. The RGBX display panel according to claim 1, wherein an aperture ratio of the X color sub-pixel is smaller than an aperture ratio of the red sub-pixel, the green sub-pixel and the blue sub-pixel.

10. A liquid crystal display device comprising an RGBX display panel, the RGBX display panel comprising:
a plurality of scan lines
a plurality of data lines, insulated from and intersecting with the plurality of scan lines;
a plurality of sub-pixels, defined by an intersection of the plurality of scan lines and the plurality of data lines and arranged in an array manner, the plurality of sub-pixels comprising a plurality of red sub-pixels, a plurality of green sub-pixels, a plurality of blue sub-pixels, a plurality of X color sub-pixels, wherein the X color is different from red, green and blue;
a plurality of first thin film transistors; and
a plurality of spacers, wherein an area ratio of a region of the X color sub-pixel blocked by the spacers to the X color sub-pixel region is a and 10%≤a<100%.

11. The liquid crystal display device according to claim 10, wherein 30%<a<70%.

12. The liquid crystal display device according to claim 10, wherein the X color sub-pixel is a white sub-pixel, a yellow sub-pixel, a cyan sub-pixel or a magenta sub-pixel.

13. The liquid crystal display device according to claim 10, wherein all of the spacers are disposed around a plurality of the X color sub-pixels or within a plurality of the X color sub-pixels.

14. The liquid crystal display device according to claim 10, wherein projections of the spacers located in the display area partially or completely overlap with an area of the X color sub-pixel.

15. The liquid crystal display device according to claim 10, wherein the spacer comprises a second spacer disposed around the X color sub-pixel, and at least partial projections of a center point of the second spacer on the horizontal plane falls within the X color sub-pixel or dose to the X color sub-pixel.

16. The liquid crystal display device according to claim 15, wherein the spacer further comprises a first spacer, the projection of the first spacer on a horizontal plane is located between two of the red sub-pixel, the green sub-pixel and the blue sub-pixel.

17. The liquid crystal display device according to claim 10, wherein all of the spacers are located outside the intersection overlapping area of the data line and the scan line.

18. The liquid crystal display device according to claim 10, wherein an aperture ratio of the X color sub-pixel is smaller than an aperture ratio of the red sub-pixel, the green sub-pixel, and the blue sub-pixel.
